(19) United States
(12) Patent Application Publication
(10) Pub. No.: US 2002/0133272 A1
(43) Pub. Date: Sep. 19, 2002

(54) Information registration method and system

(76) Inventors: Kazutoshi Ishioka, Iwata (JP); Hiroyuki Moromoto, Iwata (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/044,179

(22) Filed: Jan. 11, 2002

(30) Foreign Application Priority Data
Jan. 15, 2001 (JP) 2001-007004

(51) Int. Cl. G05D 1/00

(52) U.S. Cl. 701/1

(57) ABSTRACT

A system is arranged to enter information given by a user as voice input or text input, to recognize the contents of the voice input or text input, to generate additional information based on the result of the recognition using database information including dictionaries, and to register entered album pictures associated with the generated additional information in a memory.

### BACKGROUND OF THE INVENTION

1. Technical Field

This invention relates to a system that makes it possible to register album pictures made to correspond to additional information and to peruse the album pictures together with the additional information. In particular, this invention relates to an information registration system and information registration support system that make it possible to enter data related to the pictures, such as area names, by simple entry operations to facilitate the creation of electronic albums.

2. Background Art

The GPS (global positioning system) is a positioning system that makes it possible to locate in three dimensions (latitude, longitude, and elevation) any place on the globe where radio beams are received from a number of orbiting satellites. Since each satellite is provided with an atomic clock, the GPS system can acquire time information from each satellite.

Digital cameras with built-in GPS have been conventionally proposed that record GPS information such as position information obtained with the GPS together with pictures taken with the camera. With such digital cameras, it is possible that, when reproducing pictures taken, the places where the pictures were taken may be learned by referring to the position information obtained with the GPS and to conduct a search for target pictures by the names of the places where the pictures were taken.

When electronic albums are to be created using the pictured images taken with the conventional digital cameras, since GPS information is made to correspond to the pictured images, the pictured images may be categorized to some extent according to times or places at which the pictures were taken. Here, the electronic album is a thing that makes it possible to edit the pictured images on computers with mutual relation among them, so that they can be perused with the same feeling as with actual albums.

### SUMMARY OF THE INVENTION

However, the above conventional digital cameras are not at all for the general public because of the high cost of the GPS. Therefore, most users tend to edit electronic albums using pictured images without GPS information attached. In that case, users must do cumbersome work of presetting keywords and registering pictured images in specific categories. In particular, when pictured images are to be sorted according to position information or time information, the number of items to be registered such as latitude, longitude, etc. increases and the users are burdened.

Thus, the present invention has been made taking note of the unsolved problems associated with the prior art, with an object of providing an information registration system and an information registration support system that make it possible to enter data of area names related to pictures by simple entry operations and to facilitate creation of electronic albums.

To accomplish the above object, in an aspect of the present invention, a method is provided to register information as a subject of registration together with associated additional information, comprising the steps of: (i) acquiring information as a subject of registration; (ii) providing additional information associated with the subject; (iii) matching the additional information with stored information in a database; (iv) acquiring the matched stored information; and (v) registering and storing the subject information together with the matched stored information in an electronic album.

In the above, the method may further comprises providing comments on the subject which are stored with the subject information and the matched stored information in the electronic album. According to the above, by using the database information when inputting additional information, the additional information can effectively be formatted and edited. This can facilitate easy registration and perusal operation in the electronic album, facilitfating easy use of the electronic album.

In an embodiment, the database includes a dictionary. The subject information may comprise an image input, and the additional information may comprise name inputs of a user, a geographic location, and an object of the subject. Further, the database may include a dictionary for each input of the additional information. By this, efficiency and practicability can be improved. Additionally, the additional information may further include GPS information. In the above, the method may further comprise correcting the matched stored information on the geographic location based on the GPS information.

In an embodiment, the additional information may be inputs which are used as search terms when retrieving the subject information from the electronic album. This increases usability of the electronic album when retrieving images from the electronic album upon perusal request.

For easy input and operation, the subject information and the additional information may be provided through an input screen, and the registration may be conducted through an editing screen.

In another aspect of the invention, an information registration system is provided to register information as a subject of registration together with associated additional information, comprising: (i) a memory; (ii) a subject information entering unit for entering subject information; (iii) an additional information entering unit for entering additional information; (iv) a recognition unit for recognizing the contents of the entered additional information based on dictionary information stored in a database; (v) a formatting/editing unit for formatting and editing the additional information based on the result of recognition; and (vi) a registering unit for registering in the memory the entered subject information together with the formatted and edited additional information.

The information registration system may include the following embodiments, each being adapted independently of each other:

The additional information entering unit may be configured to enter voice input, and the recognition unit is configured to recognize the contents of the voice input.

The subject information may include pictures to be pasted in electronic albums, the additional information may include at least one of information related to the pictures or information related to a person taking the pictures, and the system further may comprise a perusal unit for providing upon perusal request the pictures in the memory together with the additional information corresponding to the requested pictures.

The additional information entering unit may be configured to enter comments on the pictures as comment information, the registration unit may be configured to register in the memory the pictures together with the comment information, and the perusal unit may be configured to provide upon perusal request the pictures together with the comment information and the other additional information.

The formatting/editing unit may be configured to prompt the person who is using the system to satisfy the contents of the additional information.

The formatting/editing unit may be configured to prompt the person who is using the system to match the database information or verify the contents of the additional information.

The database may be updated to include the newly verified contents of the additional information.

For purposes of summarizing the invention and the advantages achieved over the prior art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention.

FIG. 1 is a bloc diagram to show the constitution of the computer 100.

FIG. 2 is a flowchart of the album picture registering process.

FIG. 3 is a flowchart of the process of entering registered person's information.

FIG. 4 is a flowchart of the process of entering pictured place information.

FIG. 5 is a flowchart of the process of entering pictured subject information.

FIG. 6 shows an image of creating an electronic album.

FIG. 7 shows an image of an input screen.

In the figures, the description of symbols is as follows: 100: Computer; 30: CPU; 32: ROM; 34: RAM; 38: Interface (I/F).

### DETAILED DESCRIPTION OF THE PREFERRED EMBODIMENT

The present invention includes, but is not limited to, the following embodiments:

An information registration system according to embodiment 1 of the invention is an information registration system for registering information as the subject of registration, together with corresponding additional information, characterized by comprising: a memory means for storing the registration subject information made to correspond to the additional information, a registration subject information entering means for entering the registration subject information, an entering means for entering information given by a registered person, a recognition means for recognizing the contents of the input information entered with the entering means, an additional information generating means for generating the additional information on the basis of the result of recognition made with the recognition means, and a registering means for registering in the memory means the registration subject information entered with the registration subject information entering means and made to correspond to the additional information generated with the additional information generating means.

With the above constitution, when a registered person enters registration subject information using the registration subject information entering means and enters information using the entering means, the contents of the information entered with the entering means are recognized with the recognition means, additional information is generated with the additional information generating means, and the registration subject information entered is registered in the memory means while being made to correspond to the additional information generated with the additional information generating means.

Here, the entering means may be of any constitution as long as it is adapted to enter information given by a registered person. For example, it may be adapted to enter information given by the registered person as text information or as voice input.

The entry of information using the registration subject information entering means includes not only direct entry but also choosing one or more than one candidates prepared in advance or dynamically generated. The above is also true for the entry of information using the entering means.

The memory means is to store the registration subject information by any possible means at any possible time, and may be adapted to have stored in advance the registration subject information or store the registration subject information that is not stored in advance but entered from outside when the device of this invention is operated.

Moreover, the present system may be constituted to stand alone or as a network system of plural terminals interconnected for communication. In the latter case, each component element may be connected to any one of plural terminals as long as each element is connected to be capable of communicating. The above is also true for the information registration support systems of embodiments 5 and 6.

The information registration system according to embodiment 2 of the invention is based on the information registration system according to embodiment 1, characterized in that the entering means is adapted to enter voice input given by the registered person as voice input, and the recognition means is adapted to recognize the contents of the voice input entered with the entering means.

With the above constitution, when a registered person enters voice input using the entering means, the voice input entered with the entering means is recognized with the recognition means.

The information registration system according to embodiment 3 of the invention is based on the information registration system according to embodiment 1 or 2, characterized in that the registration subject information includes album pictures to be pasted in albums, the additional information includes either one or both of picturing information on the pictured contents of the album pictures and registered person information on the registered person, and is adapted to provide upon perusal request those album pictures in the memory means that are related to the perusal request together with additional information corresponding to the requested album pictures.

With the above constitution, when a registered person enters album pictures using the registration subject information entering means and enters information using the entering means, the contents of the information entered with the entering means is recognized with the recognition means, picturing information or registered person information is generated with the additional information generating means, and the album pictures entered are registered, together with corresponding registered person information or picturing information generated, in the memory means by means of the registering means. When a perusal request is received, some of the album pictures in the memory means that are related to the perusal request are provided together with corresponding picturing information or registered person information.

The information registration system according to embodiment 4 of the invention is based on the information registration system according to embodiment 3, characterized in that the entering means is adapted to enter comments on the album pictures as comment information, the registration means is adapted to register in the memory means the album pictures entered with the registration subject information entering means made to correspond to the comment information entered with the entering means and to the additional information generated with the additional information generating means, and is adapted to provide upon perusal request those album pictures in the memory means that are related to the perusal request together with comment information and additional information corresponding to the requested album pictures.

With the above constitution, when a registered person enters album pictures using the registration subject information entering means and enters comments using the entering means, the contents of the comment information entered with the entering means are recognized with the recognition means, picturing information or registered person information is generated with the additional information generating means, and the album pictures entered are registered, together with corresponding registered person information or picturing information generated, in the memory means by means of the registering means. When a perusal request is received, some of the album pictures in the memory means that are related to the perusal request are provided together with corresponding comment information and picturing information or registered person information.

On the other hand, to accomplish the above object, the information registration support system according to embodiment 5 of the invention is a system to be applied to the information registration system according to anyone of embodiments 1 to 4, characterized in that, when the contents of the additional information generated with the additional information generating means are determined not to satisfy specified conditions, the support system prompts the registered person to satisfy the specified conditions.

With the above constitution, when the contents of the additional information generated are determined not to satisfy specified conditions, the registered person is prompted to satisfy the specified conditions. Prompting to satisfy the specified conditions includes for example, notifying that the specific conditions are not satisfied, notifying that the specific conditions are to be satisfied, prompting entry again using the entering means or any other entering means.

Another information registration support system according to embodiment 6 of the invention is a system to be applied to the information registration system according to anyone of embodiments 1 to 4, characterized in that, when it is determined that the contents of the additional information given by the registered person or of the additional information made in advance to correspond to the registration subject information entered with the registration subject information entering means are inconsistent with the contents of the additional information generated with the additional information generating means, the system is adapted to prompt the registered person to verify the contents of the additional information.

With the above constitution, when it is determined that the contents of the additional information given by the registered person or of the additional information made in advance to correspond to the registration subject information entered are inconsistent with the contents of the additional information generated, the registered person is prompted to verify the contents of the additional information.

Prompting to verify the contents of the additional information here includes for example, notifying the presence of inconsistency, notifying part or whole of the additional information used as subject of determination to be corrected, or advising to solve the inconsistency, advising to ask if part or whole of the additional information used as subject of determination are correct.

While the information registration system and the information registration support system are proposed above to accomplish the above object, proposals according to the invention are not limited to the above but may also include a first to a third memory media described below.

The first memory medium is a computer-readable memory medium having stored a program to be applied to the information registration system as recited in embodiment 1, with the program being for executing a process realized with; a registration subject information entering means for entering the registration subject information into a computer provided with a memory means storing the registration subject information together with the related additional information, an entering means for entering information given by the registered person, a recognition means for recognizing the contents of input information entered with the entering means, an additional information generating means for generating additional information based on the result of the recognition made with the recognition means, and a registration means for registering in the memory means the registration subject information entered with the registration subject information entering means related to and together with the additional information generated with the additional information generating means.

With the above constitution, when the program stored in the memory medium is read and executed with the computer, functions and effects equivalent to those obtained with the information registration system according to embodiment 1 are provided.

The second memory medium is a computer-readable memory medium having stored a program to be applied to the information registration support system as recited in embodiment 5, with the program being for causing the computer to execute a process of prompting the registered person to satisfy the specific conditions when it is determined that the contents of the additional information generated with the additional information generating means do not satisfy the specific conditions.

With the above constitution, when the computer reads and executes the program stored in the memory medium, functions and effects equivalent to those obtained with the information registration support system according to embodiment 5 are provided.

The third memory medium is a computer-readable memory medium having stored a program to be applied to the information registration support system as recited in embodiment 6, with the program being for causing the computer to execute a process of prompting the registered person to verify the contents of the additional information when it is determined that the contents of the additional information given by the registered person or of the additional information made in advance to correspond to the registration subject information entered with the registration subject information entering means are inconsistent with the contents of the additional information generated with the additional information generating means.

With the above constitution, when the computer reads and executes the program stored in the memory medium, functions and effects equivalent to those obtained with the information registration support system according to embodiment 6 are provided.

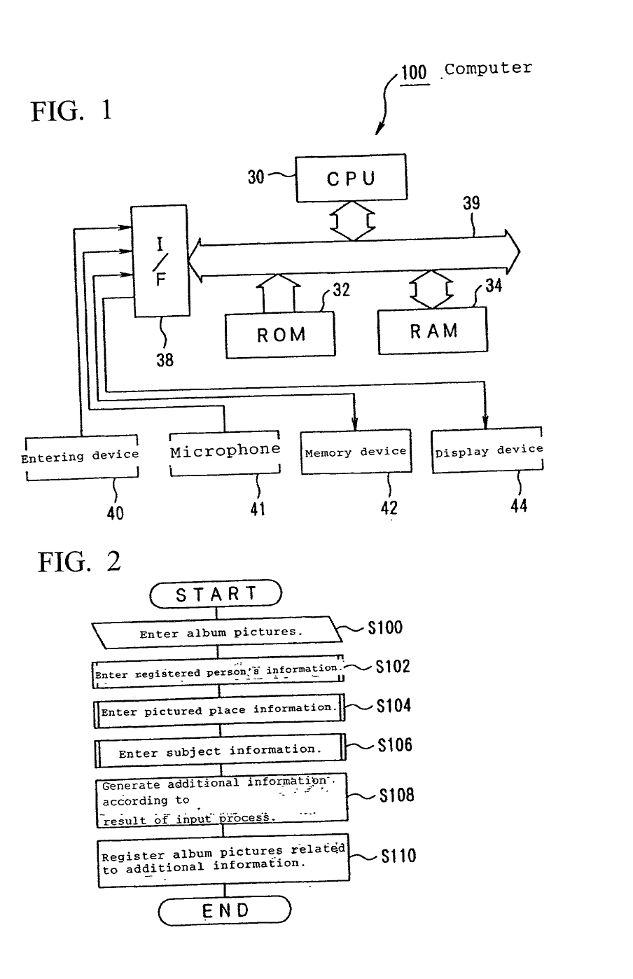

An embodiment of the invention will be hereinafter described in reference to the appended drawings, in which FIGS. 1 to 7 relate to an embodiment of the invention.

The present embodiment is an application of the invention to a case as shown in FIG. 1 in which electronic albums are created by registering plural album pictures together with related additional information by means of a computer 100 and the album pictures in the created electronic albums are made perusable together with related additional information.

First, the constitution of the computer 100 will be described referring to FIG. 1 which is a bloc diagram to show the constitution of the computer 100.

As shown in FIG. 1, the computer 100 is made up of a CPU 30 for controlling numerical operations and entire system according to a control program, a ROM 32 with its specified region storing in advance the control program, etc. for the CPU 30, a RAM 34 for storing data read from the ROM 32 and calculated results necessary in the calculating process with the CPU 30, and an I/F 38 interfacing data to and from external devices. The above components are interconnected through a bus 39 for reciprocally transferring data.

To the I/F 38 are connected external devices; an entering device 40 including a keyboard and a mouse, as human interfaces, to permit data entry, a microphone 41 for entering voice input, a memory device 42 for storing data and tables in the form of files, and a display device 44 for displaying images according to image signals.

In the memory device 42 are stored; a registered persons directory listing the names of registered persons who have registered electronic albums, a area names dictionary containing lists of place names information by areas of the whole country, and a subject names dictionary in which names of pictured subjects, album pictures, are registered in a list. Those dictionaries are used when generating additional information to be compared with the information entered by users.

In the memory device 42 are stored or can be stored electronic albums, with each album registering plural album pictures with related additional information. Here, the additional information includes for example registered person information showing the names of registered persons in electronic albums, pictured places information showing the names of places where the album pictures are taken, and pictured subjects information showing the names of subjects of the album pictures.

The CPU 30 is made up of a micro-processing unit MPU and others, and adapted to start up a specified program stored in a specified region of the ROM 32, and to execute album picture registering process shown in the flowchart of FIG. 2 according to the program. FIG. 2 is a flowchart of the album picture registering process.

The album picture registering process is to generate additional information on the basis of information entered by the user and to register the album pictures in the memory device 42 together with the additional information related to the album pictures. The process is adapted to go first to the step S100 when the album picture registering process is executed with the CPU 30 as shown in FIG. 2.

In the step S100, album pictures are entered. In the next step S102, process of entering the information on the registered person is executed. In the next step S104, process of entering pictured place information is executed. In the next step S106, process of entering pictured subject information is executed. Then the process goes to the step S108.

In the next step S108, additional information is generated on the basis of the result of the entering steps S102 to S106. The process then goes to the step S110 in which the album pictures entered in the step S100 are registered in the memory device 42 together with related additional information generated, ending a series of steps and returning to the first step.

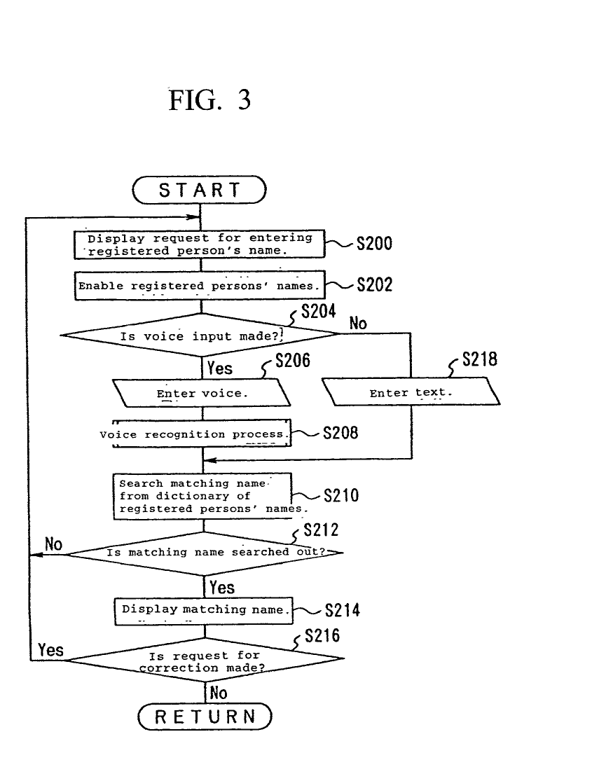

Next, the process of entering the registered person information in the step S102 will be described in detail in reference to FIG. 3 which is a flowchart of the process of entering the registered person information.

The process of entering the registered person information is adapted, when it is executed in the step S102, to go first to the step S200 as shown in FIG. 3.

In the step S200, an instruction that the registered person's name be entered is displayed on the display device 44. In the next step S202, the registered persons directory is set effective. In the step S204, whether a voice input entry is present is determined and, if it is determined affirmative (yes), the process goes to the step S206.

In the step S206, the user's voice is entered through the microphone 41. In the next step S208, voice recognition process is executed to recognize the contents of the entered voice input and convert them into text information. In the next step S210, the result of the voice recognition, the text information, is used to search a matching name of the registered person from the registered persons directory. Then the process goes to the step S212.

In the step S212, whether the matching name of the registered person has been searched out by the search in the step S210 is determined. If the determination proves affirmative (yes), the process goes to the step S214 to display the matching name of the registered person searched out on the display device 44, and moves on to the step S216.

In the step S216, whether a request for correcting the contents has been made by the user is determined and, when the determination proves to be negative (no), the series of steps are terminated. In case the determination is affirmative (yes), the process moves on to the step S200.

On the other hand in the step S212, if the search of the step S210 proves that the matching name of the registered person has not been searched out (no), the process goes to the step S200.

On the other hand, in case the step S204 determines that no voice entry is present (no), the process goes to the step S218, a text entry is made through the entering device 40, and the process goes to the step S210.

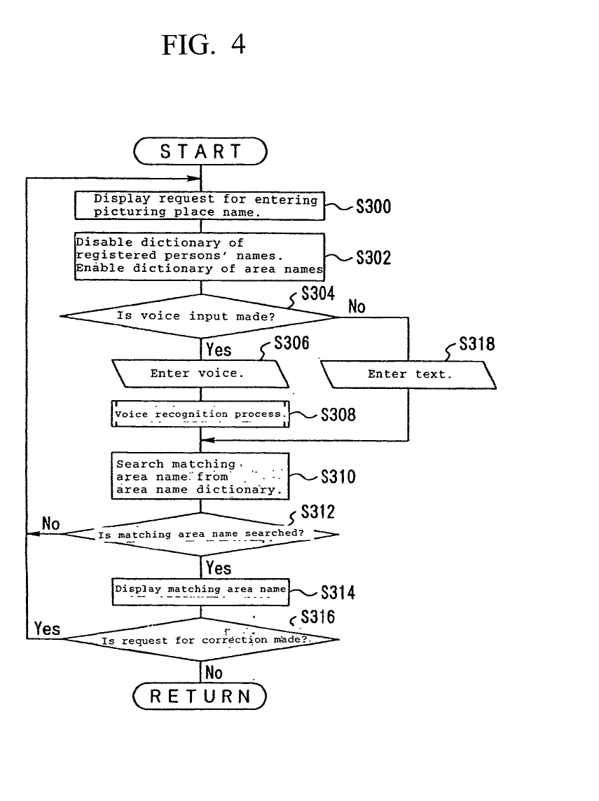

Next, the process of entering the pictured place information in the step S104 will be detailed in reference to FIG. 4. FIG. 4 is a flowchart of the process of entering the pictured place information.

The process of entering the pictured place information is adapted, when it is executed in the step S104, to move first on to the step S300 as shown in FIG. 4.

In the step S300, an instruction is displayed on the display device 44 to the effect that the pictured place name be entered. In the next step S302, the registered persons directory is set to be ineffective and the place names dictionary is set to be effective. In the next step S304, presence of voice input is verified. If it proves to be affirmative (yes), the process goes to the step S306.

In the step S306, user's voice is entered through the microphone 41, followed by the step S308 in which the contents of the voice input entered are recognized and converted into text information. In the next step S310, a matching place is looked up in the area name dictionary according to the result of the voice recognition, the text information. And the process goes to the step S312.

In the step S312, whether a matching area name has been searched out in the search of the step S310 is determined. If it proves affirmative (yes), the process goes to the step S314 to display the matching area searched out on the display device 44. And the process goes to the step S316.

In the step S316, whether the user has requested correction of the contents is determined. If the determination proves to be negative (no), the series of steps are terminated to go to the first step; otherwise (yes), the process goes to the step S300.

On the other hand, in case it is determined in the step 312 that no matching area has been searched out in the search of the step S310 (no), the process goes to the step S300.

On the other hand, in case the step S304 determines that no voice input has been made (no), the process goes to the step S318 to enter text through the entering device 40, and moves on to the step S310.

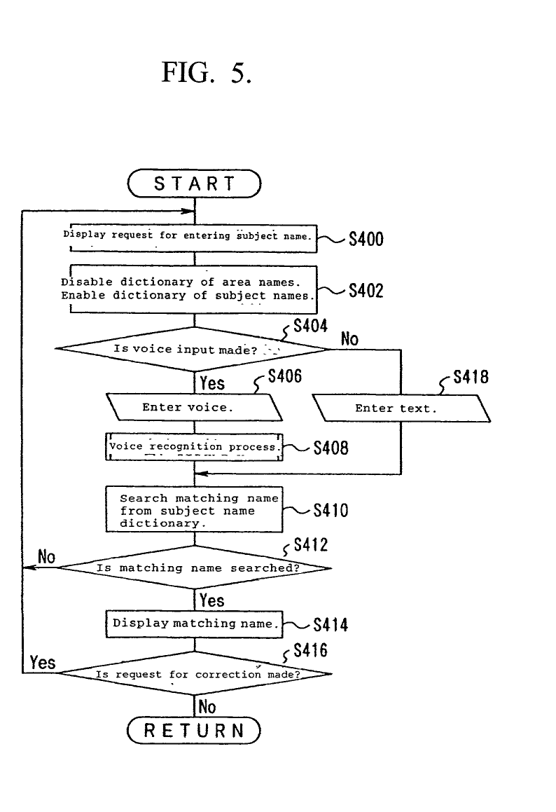

Next, the process of entering the pictured subject information in the step S106 will be described in detail in reference to FIG. 5. FIG. 5 is a flowchart of the process of entering the pictured subject information.

The process of entering the pictured subject information is adapted, when it is executed in the step S106, to go first to the step S400 as shown in FIG. 5.

In the step S400, an instruction that pictured subject names be entered is displayed on the display device 44. In the next step S402, the area names dictionary is set to be ineffective. In the step S404, whether a voice input is made is determined and, if it is determined affirmative (yes), the process goes to the step S406.

In the step S406, the user's voice is entered through the microphone 41. In the next step S408, voice recognition process is executed to recognize the contents of the entered voice input and convert them into text information. In the next step S410, the result of the voice recognition, the text information, is used to search a matching name of the pictured subject from the pictured subject name directory. Then the process goes to the step S412.

In the step S412, whether the matching name of the pictured subject has been searched out by the search in the step S410 is determined. If the determination proves affirmative (yes), the process goes to the step S414 to display the matching name of the pictured subject searched out on the display device 44, and moves on to the step S416.

In the step S416, whether a request for correcting the contents has been made by the user is determined and, when the determination proves to be negative (no), the series of steps are terminated. In case the determination is affirmative (yes), the process moves on to the step S400.

On the other hand in the step S412, if the search of the step S410 proves that the matching name of the pictured subject has not been searched out (no), the process goes to the step S400.

On the other hand, in case the step S404 determines that no voice entry is present (no), the process goes to the step S418, a text input is made through the input device 40, and the process goes to the step S410.

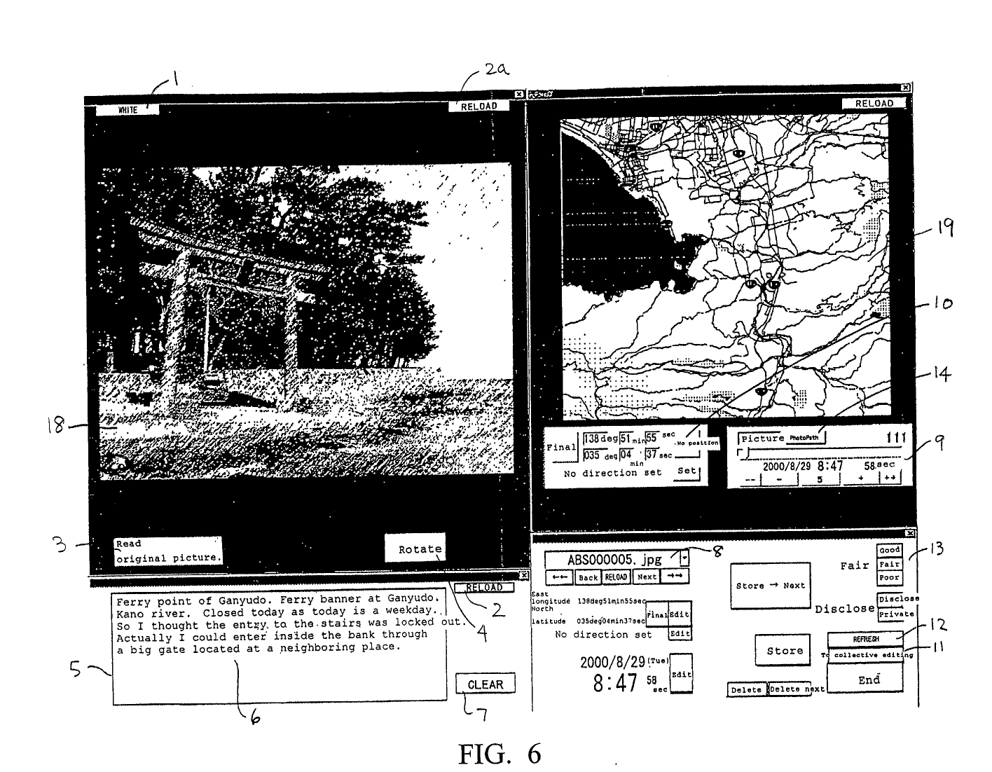

Next, the actions of the above embodiment will be described in reference to FIG. 6 which shows an image of creating an electronic album.

To roughly describe how to create an electronic album, first as shown in FIG. 6 an album picture intended to be pasted in the album is entered and information necessary for generating additional information is entered by voice or text. Thus, registration of one album picture is over. The same step is repeated for all the album pictures to be pasted in the electronic album. The information required to generate additional information is entered in the creating image shown in FIG. 6. In case the information is to be entered by voice, an operation button (not shown) for entering voice information is pressed to instruct to that effect.

In FIG. 6, the background of the screen can be switched between “white” and “black” which are indicated in a space 1. Processing operation of an image 18 (the subject of registration) on the screen such as cutting the image 18 in a rectangle can be undone by clicking an indicator 2. The result is indicated in a space 2a. The previous image can be retrieved at any times by clicking an indicator 3. The image can be rotated at 90 degrees by clicking an indicator 4. A column 5 is for inputting or showing additional information associated with the image 18. In the column 5, messages 6 are indicated in the following order: title, name of the object, keyword, comments, and category (e.g., separated by commas). When inputting the messages 6 into the column 5, the messages can be cleared by clicking an indicator 7. A symbol or number 8 is assigned to the image 18 or this screen. In this system, a GPS system is installed, and a map 19 is indicated. The GPS information 10 is automatically shown. If no GPS system is used, the location where the image is taken is inputted by a user. The location is indicated on the map 19. The registered or previous images can also be indicated on the map 19 by operating a section 9 (here, the image's number is 111). Switching between the current GPS data and the recorded data can be done by clicking an indicator 14. The screen can be edited with one click by clicking an indicator 11. The previously edited result can be retrieved by clicking an indicator 12. The input can be evaluated at three levels by clicking one of three sections 13.

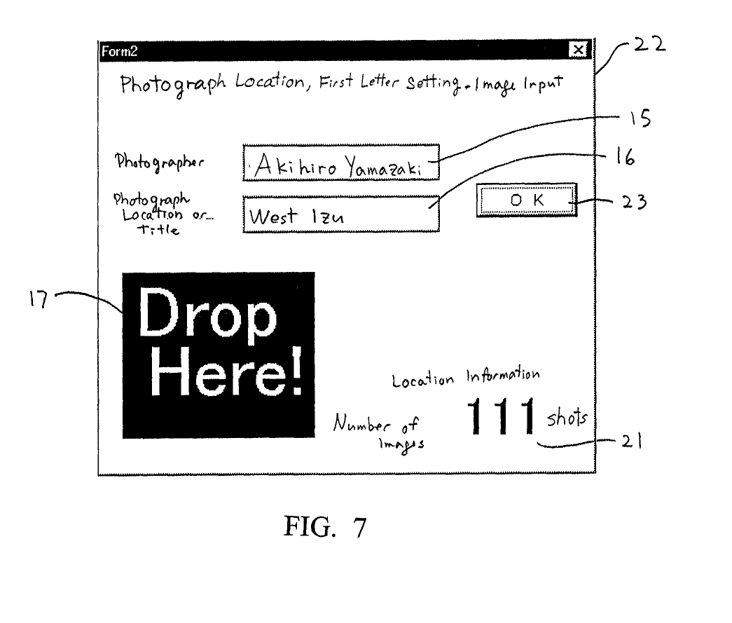

The use information can be inputted first in an input screen which can be a separate screen. In this case, the above screen (FIG. 6) is an formatting/editing screen. FIG. 7 show an image of an input screen 22. The name is inputted in a section 15, and the location of the image is inputted in a section 16. These inputs can be screened and confirmed by using dictionary information from a database. Even if there is no matching information found in the database, the use can input the information by clicking a bottom 23, moving to the editing screen of FIG. 6. The image (from a digital camera) and the GPS information (from a GPS device) are transferred to an area 17. If the GPS information is registered, that is indicated in an area 20. The number of images registered is indicated in a section 21 (here, 111 images are registered). FIG. 6 and FIG. 7 are simply examples, and the invention should not be limited thereto.

The following is a detailed explanation of the process of registering one album picture, as part of an electronic album creating process.

To register album picture, the user enters first an album picture. Then, the CPU 30 displays an instruction that the registered person's name be entered through the steps S100 and S200.

Next, when the user according to the entry instruction enters the registered person's name by voice for example, the registered persons directory is set to become effective through the steps S202 and S206, and voice input is entered through the microphone 41. The contents of the voice input entered are recognized through the steps S208 and S210 and converted into text information, and on the basis of the converted text information, a matching name of registered person is searched from the registered persons directory. When the matching name of the registered person is searched out through the search, the process goes through the steps S214 and S300 to display the matching name of the registered person. If no request for correction is made, an instruction is displayed to enter the pictured place name.

Next, when the user in response to the entry instruction enters the name of the pictured place by voice for example, the registered persons directory is set to become ineffective and the place names dictionary is set to become effective through the steps S302 to S306, and voice input is entered through the microphone 41. And through the steps S308 and S310, the contents of the voice entered through the microphone 41 are recognized and converted into text, and a matching area name is searched out from the area names dictionary on the basis of the converted text information. When the matching area name is searched out through the search, the matching area is displayed through the steps S314 and S400. If no request for correction is made, an instruction is displayed to enter the pictured subject name.

Next, when the user according to the entry instruction enters the pictured subject name by voice for example, the area names directory is set to become ineffective and the area names dictionary is set to become effective through the steps S402 and S406, and voice input is entered through the microphone 41. Through the steps S408 and S410, the contents of the voice input entered are recognized and converted into text information, and on the basis of the converted text information, a matching name of pictured subject is searched from the pictured subject dictionary. When the matching name of the pictured subject is searched out through the search, the process goes through the steps S414, S108, and S100 to display the matching name of the pictured subject. If no request for correction is made, additional information is generated on the basis of the entry processes of the steps S102 to S106 and the album picture entered is related to the additional information generated, and registered in the memory device 42.

While the above embodiment is arranged to enter the registered person's name, the pictured place name, and the pictured subject name by voice, the entry may also be made by text. In that case, difference from the above, for the entry of the registered person's name for example, is that the text is entered through the input device 40 through the steps S218 and S210, and the matching name of the registered person is searched out of the registered persons directory on the basis of the text information entered. The above is true for the entry of the picturing information, and the pictured subject names.

As described above, this embodiment is arranged that the information given by the user is entered as voice input or text information, the contents of the voice input or text information entered are recognized, additional information is generated on the basis of the result of the recognition, and the album picture entered is related to the additional information generated and registered in the memory device 42.

With the above arrangement, since the additional information is generated from the voice input or text information given by the user, it is possible to register album pictures attached with additional information through an entry operation that is simpler than that of the conventional arrangement.

In the above embodiment, the album picture corresponds to the registration subject information specified in embodiment 1 or 3, the memory device 42 to the memory means in embodiment 1 or 3, the step S100 to the registration subject information entering means in embodiment 1; and the steps S206, S218, S306, S318, S406, and S418 to the entering means in embodiment 1 or 2. The steps S208, S308, and S408 correspond to the recognition means in embodiment 1 or 2. The step S108 corresponds to the additional information generating means in embodiment 1. The step S110 corresponds to the registering means specified in embodiment 1.

While the above embodiment is arranged to enter the registered person's name, the pictured place name, and the pictured subject name directly by voice or text, the arrangement is not limited to the above but may be alternatively arranged that comments on the album pictures are entered as comment information, the contents of the entered comment information are recognized, additional information is generated on the basis of the result of the recognition, an the album pictures entered are registered, with related additional information attached, in the memory device 42.

In this way, the user can register album pictures attached with related additional information by simply entering the comments.

Concerning the above embodiment, while no specific explanation is made about verifying the information entered by the user, it may be arranged for example that, when the contents of the additional information generated on the basis of the result of recognition are determined not to satisfy specified conditions, the user is prompted to satisfy the specified conditions. Here, the specified conditions may include for example registered person information, pictured place information, and pictured subject name information. Here, in case the contents of the generated additional information includes for example only the registered person name information and the pictured place name information, it may be arranged to indicate the need of entering missing information on the pictured subject name.

Thus, in case the contents of the additional information generated from the information given by the user are incomplete when the additional information is to be registered, the user is prompted to complete the contents, so that the probability of incomplete contents of the additional information is lowered. Moreover, since the user can compare the contents of the additional information generated from the information given by the user with the contents of the additional information necessary for the registration, and may enter only the missing portion, it is possible to register the album images, with additional information attached, by relatively simple entry operations.

Also concerning the above embodiment, while no specific explanation is made about verifying the information entered by the user, it may be arranged for example that, when it is determined that the contents of the additional information related in advance to the album pictures or of the additional information given by the user are inconsistent with the contents of the additional information generated on the basis of the result of the recognition, the user is prompted to verify the contents of the additional information. For example, in case GPS information is attached to an album picture and the area specified with the GPS information is in disagreement with the area included in the additional information generated on the basis of the recognition result, a display is made to indicate the presence of disagreement.

Thus, in case inconsistency might be present in the contents of additional information given by the user at the time of registering the additional information, the user is prompted to verify the contents of the additional information. Therefore, possibility of presence of inconsistency in the contents of the additional information is reduced.

The above embodiment, concerning the area names dictionary, is arranged to search areas using a single area names dictionary. However, it may also be arranged to search with switched use of plural area names dictionaries. For example, it may be arranged as follows; Tohoku (Northeastern) area names dictionary, Kanto area names dictionary, Kinki area names dictionary, etc. are prepared. Area information is extracted from the text information, the result of voice recognition. If the extracted area information is about the Kanto area, a matching place is searched in the Kanto area names dictionary based on the text information, the result of the voice recognition. The above arrangement is also true for the registered persons directory and the pictured subject names dictionary.

The above embodiment is constituted to search matching information in the steps S210, 310, and 410. To put it more specifically, the matching information is searched as follows: For example, to search in the step S310 a matching area name in an area names dictionary based on text information, or the result of voice recognition, administrative area division names such as prefecture names and city names are registered and held as area name information in an area names dictionary, and the information on the area that matches an administrative area division name included in the text information, or the result of voice recognition, is searched in the area names dictionary. The above is also true for the search for the registered person's name and the pictured subject name.

The above embodiments are all described as executing a control program prestored in the ROM 32 to execute the process shown in the flowchart of FIGS. 2 to 5. However, it may also be arranged to read the program from a memory medium storing a program specifying the above procedure into a RAM 34 and execute the program.

Here, the memory medium may be any computer-readable memory medium irrespective of the method of reading; a semiconductor memory medium such as a RAM, and ROM; a magnetic memory medium such as FD and HD; an optical reading type memory medium such as a CD, CDV, LD, and DVD; or a magnetic storing type/optical reading type medium such as MO.

The above embodiments are described as applications of this invention in which, as shown in FIG. 1, using a computer 100, an electronic album is created by registering plural album pictures together with related additional information, and the album pictures attached with the additional information in the created electronic album are made available for perusal. However, this invention is not limited to the above applications but may include other applications without departing from the gist of the invention.

As described above, with the information registration system according to embodiment 1 of the invention, since the additional information is generated from the information given by the registered person, an effect is obtained that registration subject information with additional information attached may be registered by simpler entry operations in comparison with conventional arrangement.

With the information registration system according to embodiment 2 of the invention, another effect is obtained that a registered person can register registration subject information with additional information attached simply by entering voice input using an entry means.

With the information registration system according to embodiment 3 of the invention, since registered person's information or picturing information is generated from the information given by the registered person, still another effect is obtained that album pictures with registered person's information or picturing information attached may be registered by relatively simple entry operations.

With the information registration system according to embodiment 4 of the invention, still another effect is obtained that a registered person can register album pictures, with registered person's information or picturing information attached, by simply entering comments through an entering means.

On the other hand with the information registration support system according to embodiment 5 of the invention, in case there is any omission in the contents of the additional information generated from the information given by the registered person at the time of registering the additional information, since the user is prompted to satisfy specified conditions, an effect is provided that the possibility of omission in the additional information is reduced. Furthermore, since the user can compare the contents of the additional information generated from the information given by the registered person with the contents of the additional information required for the registration, and has only to enter the missing portion, the registration subject information can be registered, with additional information attached, through relatively simple entry operations.

With the information registration support system according to embodiment 6 of the invention, in case presence of inconsistency is possible in the contents of additional information generated on the basis of the information given by the user at the time of registering the additional information, the user is prompted to verify the contents of the additional information. Thus, still another effect is provided that the possibility of presence of inconsistency in the contents of the additional information is reduced.

The present invention can be adapted to be connected to the Internet, and the electronic album can be created in a web using a suitable browser. United States Patent application No. unknown, filed Dec. 17, 2001, entitled “Method, Device, And Mobile Toot For Remotely Creating Electronic Albums”, (which claims priority to Japanese patent application No. 2000-384242, filed Dec. 18, 2000) discloses the remotely creating an electronic album, and the disclosure of which is herein incorporated by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A method for registering information as a subject of registration together with associated additional information, comprising the steps of:
acquiring information as a subject of registration;
providing additional information associated with the subject;
matching the additional information with stored information in a database;
acquiring the matched stored information; and
registering and storing the subject information together with the matched stored information in an electronic album.

2. The method according to claim 1, further comprising providing comments on the subject which are stored with the subject information and the matched stored information in the electronic album.

3. The method according to claim 1, wherein the database includes a dictionary.

4. The method according to claim 1, wherein the subject information comprises an image input, and the additional information comprises name inputs of a user, a geographic location, and an object of the subject.

5. The method according to claim 4, wherein the database includes a dictionary for each input of the additional information.

6. The method according to claim 4, wherein the additional information further includes GPS information.

7. The method according to claim 6, further comprising correcting the matched stored information on the geographic location based on the GPS information.

8. The method according to claim 1, wherein the additional information is inputs which are used as search terms when retrieving the subject information from the electronic album.

9. The method according to claim 1, wherein the subject information and the additional information are provided through an input screen, and the registration is conducted through an editing screen.

10. An information registration system for registering information as a subject of registration together with associated additional information, comprising:
a memory;
a subject information entering unit for entering subject information;
an additional information entering unit for entering additional information;
a recognition unit for recognizing the contents of the entered additional information based on dictionary information stored in a database;
a formatting/editing unit for formatting and editing the additional information based on the result of recognition; and
a registration unit for registering in the memory the entered subject information together with the formatted and edited additional information.

11. The information registration system according to claim 10, wherein the additional information entering unit is configured to enter voice input, and the recognition unit is configured to recognize the contents of the voice input.

12. The information registration system according to claim 10, wherein the subject information includes pictures to be pasted in electronic albums, the additional information includes at least one of (I) information related to the pictures or (II) information related to a person taking the pictures, and the system further comprises a perusal unit for providing upon perusal request the pictures in the memory together with the additional information corresponding to the requested pictures.

13. The information registration system according to claim 12, wherein the additional information entering unit is configured to enter comments on the pictures as comment information, the registration unit is configured to register in the memory the pictures together with the comment information, and the perusal unit is configured to provide upon perusal request the pictures together with the comment information and the other additional information.

14. The information registration system according to claim 10, wherein the formatting/editing unit is configured to prompt the person who is using the system to satisfy the contents of the additional information.

15. The information registration system according to claim 10, wherein the formatting/editing unit is configured to prompt the person who is using the system to match the database information or verify the contents of the additional information.

16. The information registration system according to claim 15, wherein the database is updated to include the newly verified contents of the additional information.

17. An information registration system for registering information as a subject of registration, together with corresponding additional information, characterized by comprising: a memory means for storing the registration subject information made to correspond to the additional information, a registration subject information entering means for entering the registration subject information; an entering means for entering information given by a registered person; a recognition means for recognizing the contents of the input information entered with the entering means; an additional information generating means for generating the additional information on the basis of the result of recognition made with the recognition means; and a registering means for registering in the memory means the registration subject information entered with the registration subject information entering means and made to correspond to the additional information generated with the additional information generating means.

18. The information registration system according to claim 17, characterized in that the entering means is adapted to enter voice given by the registered person as voice information, and the recognition means is adapted to recognize the contents of the voice information entered with the entering means.

19. The information registration system according to claim 17, characterized in that the registration subject information includes album pictures to be pasted in albums, the additional information includes either one or both of picturing information on the pictured contents of the album pictures and registered person information on the registered person, and is adapted to provide upon perusal request those album pictures in the memory means that are related to the perusal request together with additional information corresponding to the requested album pictures.

20. The information registration system according to claim 19, characterized in that the entering means is adapted to enter comments on the album pictures as comment information, the registration means is adapted to register in the memory means the album pictures entered with the registration subject information entering means made to correspond to the comment information entered with the entering means and to the additional information generated with the additional information generating means, and the system is adapted to provide upon perusal request those album pictures in the memory means that are related to the perusal request together with comment information and additional information corresponding to the requested album pictures.

21. An information registration support system for use in the information registration system according to claim 17, characterized by being adapted, when it is determined that the contents of the additional information generated with the additional information generating means does not satisfy specific conditions, to prompt the registered person to satisfy the specific conditions.

22. An information registration support system for use in the information registration system according to claim 17, characterized in that, when it is determined that the contents of the additional information given by the registered person or of the additional information made in advance to correspond to the registration subject information entered with the registration subject information entering means are inconsistent with the contents of the additional information generated with the additional information generating means, the system is adapted to prompt the registered person to verify the contents of the additional information.
